(19) United States
(12) Patent Application Publication
(10) Pub. No.: US 2026/0070622 A1
(43) Pub. Date: Mar. 12, 2026

(54) LAMINATED WALL SCANNER FOR RECREATIONAL VEHICLES

(71) Applicant: Thor Tech, Inc., Elkhart, IN (US)

(72) Inventor: Carl Smith, Elkhart, IN (US)

(73) Assignee: Thor Tech, Inc., Elkhart, IN (US)

(21) Appl. No.: 19/324,951

(22) Filed: Sep. 10, 2025

Related U.S. Application Data
(60) Provisional application No. 63/693,485, filed on Sep. 11, 2024.

(51) Int. Cl. B62D 65/00; B25J 9/00; B25J 9/16; B25J 11/00; B25J 19/02

(52) U.S. Cl. CPC B62D 65/005; B25J 9/0093; B25J 9/1682; B25J 11/005; B25J 19/02

(57) ABSTRACT

A wall scanner system and method for scanning a body panel of an RV or other vehicle with one or more penetrative imaging sensors is disclosed. The body panel is scanned to identify the locations of one or more components within and/or behind the body panel so that a fabrication operation may be planned out to avoid the one or more components. The body panel may be disposed within a workable range of one or more industrial robots so that the robots may traverse the body panel with one or more penetrative imaging sensors. One or more industrial robots may be equipped with fabrication tools for carrying out the fabrication operation based at least in part on the scan results.

### CROSS-REFERENCE TO RELATED APPLICATIONS

This application claims benefit to U.S. Provisional Application Ser. No. 63/693,485 filed Sep. 11, 2024.

### TECHNICAL FIELD

The present disclosure relates generally to automated manufacturing systems and methods employed thereby, and more particularly, automated manufacturing systems and methods for the construction, fabrication, and assembly of recreational vehicles (RVs) and components and structures thereof.

### BACKGROUND

Body panels of RVs, such as the walls, roof, floor, and the like, are typically made of various materials (e.g., wood, rubber, fiberglass, aluminum, plastics, and the like) which are formed as or as part of laminated and/or laminated composite structures. Often times, various types of wiring, piping, and the like may be encased within these panels and/or within this laminated structure. Additionally and/or, once a body panel is mounted to a frame, truss, or the like of an RV, the panel is secured to the underlying structure and may have additional wires, piping, and or the like attached thereto. Depending on the intended floorplan and/or configuration of the RV, there may be a need to make any number of cutouts on the body panel to accommodate features such as doors, windows, wheel wells, access panels or doors, air vents, air conditioning units, and/or the like, without limit. These cutouts may be made either during fabrication of the body panel itself or after the body panel has been installed upon the RV structure.

### SUMMARY

In one aspect, a scanner system for scanning a body panel of an RV is disclosed, the system including a workstation for supporting the body panel of the RV, at least one industrial robot equipped with at least one penetrative imaging sensor for scanning the body panel, and a controller. The controller is configured to control the robot to scan the body panel with the sensor, to identify at least one component within or behind the body panel that is detectable by the at least one penetrative imaging sensor, and to plan a fabrication operation based at least in part on the detected location of the at least one component.

In another aspect, a method for scanning a body panel of an RV is disclosed, the method including disposing a body panel within a workable range of at least one industrial robot, scanning the body panel with at least one penetrative imaging sensor attached to the at least one industrial robot, identifying at least one component within or behind the body panel that is detectable by the at least one penetrative imaging sensor, and planning a fabrication operation based at least in part on a detected location of the at least one component.

These and additional features provided by the aspects described herein will be more fully understood in view of the following detailed description, in conjunction with the drawings.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts an illustrative RV as described and illustrated herein;

FIG. 2 schematically depicts a perspective view of an illustrative wall scanner system as described and illustrated herein;

FIG. 3 schematically depicts a perspective view of an illustrative wall scanner system as described and illustrated herein;

FIG. 4 schematically depicts an illustrative planning diagram for planning a fabrication step as described and illustrated herein; and

FIG. 5 depicts an illustrative method for scanning an RV body panel as described and illustrated herein.

### DETAILED DESCRIPTION

Due to the size and/or unwieldiness of RV body panels, or the current state of assembly (e.g., a partially assembled RV or a fully assembled RV, as the case may be for retrofits or aftermarket modifications), it can be difficult to accurately plan out fabrication operations (e.g., cutting, welding, drilling, and/or the like) that are carried out on a first side of the panel, either for process and/or for aesthetic reasons, in order to avoid certain components and/or structural elements (e.g., wires, piping, fixtures, mounting brackets, frames and/or the like) on a second side of the panel. In some cases, even accessing the components or structural elements from the second side to take measurements can be difficult or impossible, which further complicates any planning endeavors carried out on the first side. Accordingly, there exists a need for a system and process whereby components may be reliably and accurately avoided when conducting fabrication operations so that the overall assembly and/or modification of RVs may be carried out more quickly and/or with less waste or nonconforming components.

Aspects described herein pertain to wall scanner systems and methods for scanning a body panel of an RV with one or more penetrative imaging sensors to identify one or more components within and/or behind the body panel so that a fabrication operation may be planned out to avoid the one or more components. The body panel may be disposed within a workable range of one or more industrial robots so that the robots may traverse the body panel with one or more penetrative imaging sensors and/or may carry out the subsequently planned fabrication operation.

As used herein, “top,” “bottom”, “up,” and “down” refer to directions relative to gravity and a corresponding height direction of the RV, body panel, and/or wall scanner.

As used herein, the term “body panel” may refer to any roof, wall, front cap and/or nosecone, decking, extensions, floor panels, and/or the like, and/or any portion thereof, without limit. While RVs are used throughout this disclosure as a principal example, the disclosure is not so limited and may be extended to any body panels or the like where there may be difficulties in identifying components behind a panel structure that need to be avoided when conducting in-situ fabrication operations or the like.

As used herein with respect to a body panel, “exterior” or “exterior surface” refers to an outward-facing side of the panel that is exposed to or oriented towards an ambient environment outside of a space at least partially enclosed by the body panel. Conversely, as used herein with respect to a body panel, “interior” or “interior surface” refers to the inward-facing side of a panel oriented towards or exposed to the space at least partially enclosed by the body panel.

As used herein, the term “occupant” may refer to a driver, passenger, and/or any combination and/or number thereof, and/or the like, without limit.

As used herein, the term “penetrative imaging sensor” refers to any sensing apparatus capable of detecting, measuring, or imaging internal structures, subsurface features, hidden defects, or material properties within or through an object without requiring direct physical access or an unobstructed line of sight to the detected feature. Penetrative imaging sensor may utilize electromagnetic radiation, acoustic waves, magnetic and/or electromagnetic fields, and/or other field effects that propagate through, are absorbed by, reflected from, or scattered by the target material to generate data representative of internal characteristics. Penetrative imaging sensors may include, but are not limited to, sensors employing ionizing radiation (e.g., X-ray, gamma ray, or neutron imaging systems), non-ionizing electromagnetic radiation sensors (e.g., microwave imaging, millimeter wave scanners, terahertz imaging sensors, radio frequency detection systems), ultrasonic and/or acoustic imaging transducers, magnetic resonance and/or nuclear magnetic resonance sensors, electromagnetic induction sensors, capacitive tomography systems, and/or any combination thereof. The penetrative imaging sensor may operate in a transmission mode (e.g., detecting effects propagated through the object), in a reflection/backscatter mode (e.g., detecting effects returned from within the object), and/or may operate in an emission mode (e.g., detecting effects emitted by the object itself).

It is noted that, while cutouts and cutting are used here as the primary illustrative example, it is also contemplated that those schemes described herein may be applied to other potentially destructive (directly or indirectly) fabrication steps (e.g., welding, drilling, punching, riveting, milling, and/or the like, without limit) that need to avoid damaging other components in and/or around a body panel without departing from the spirit of this disclosure.

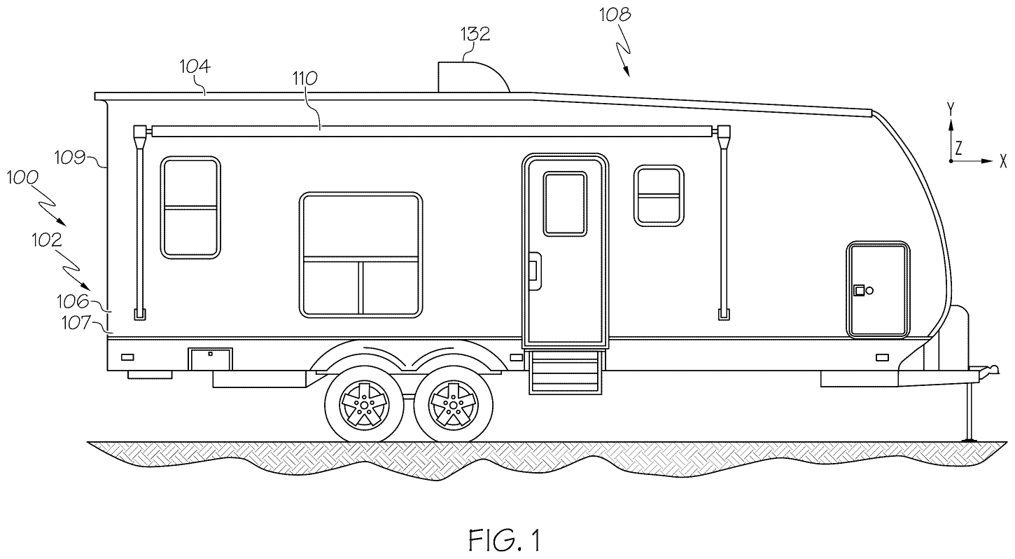

Turning now to FIG. 1, an illustrative RV 100 is shown having an RV body 102 with a plurality of body panels 107, including an RV roof 104 and one or more RV sidewalls 106. The RV body 102 may enclose a living or other space in which an occupant may reside, ride, recreate, or the like. Additionally and/or alternatively, the RV body 102 may include one or more components attached thereto, such as an awning 110 attached and/or mounted to the RV wall 106 and an air conditioning unit 132 attached and/or mounted to the RV roof 104.

As noted above, each body panel 107 may be formed from wood, plastic, fiberglass, metal, and/or the like, and/or some composite (e.g., a laminated composite) thereof, without limit. Each body panel 107 is supported on the RV by a frame, truss structure, and/or the like (not shown) that may be formed, for example, from aluminum tubing, wood, extruded metal, composites (e.g., fiberglass, carbon fiber), plastic, and/or the like, without limit. The frame is typically disposed on and/or attached to an interior side of the body panel 107. Other components, such as wiring, piping, fittings, fasteners, mounting plates, support brackets, and/or the like, without limit, may also be disposed on and/or attached to an interior side of the body panel 107. In some aspects, such as, but not limited to, those aspects in which the body panel 107 is formed as a laminated composite, these other components may be, additionally or alternatively, routed through and/or disposed within the laminated structure of the body panel 107, such as between layers of the body panel 107. These other components may formed from wood, metal, plastic, composites, and/or the like.

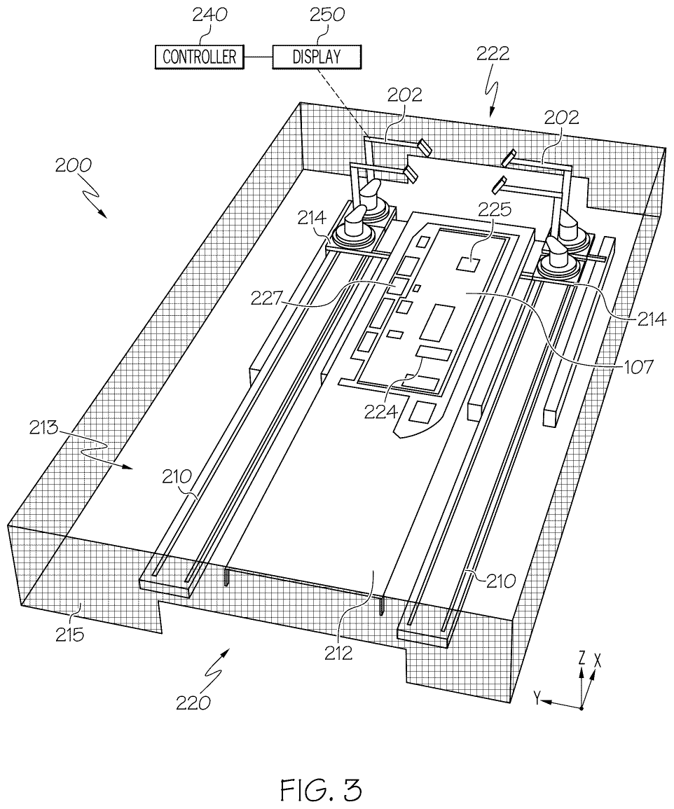

One or more cutouts 224 (FIG. 3) may be formed in and/or on the body panel 107, such as where an RV door, window, access hatch, wheel wells, and/or the like are to be disposed. Cutouts 224 are typically formed (e.g., by cutting) in the body panel 107 and may be formed before and/or after the body panel 107 is mounted to the RV 100 and/or before and/or after any of the components are mounted/disposed within the body panel 107. For example, in some aspects, wiring may be run within or attached to the body panel 107 before the body panel is mounted to the RV 100. In some aspects, cutouts 224 are made after the RV 100 has already been assembled, such as for a retrofit or aftermarket customization.

In any case, either due to the nature of the body panel 107 (e.g., its size, weight, and/or unwieldiness), position of the body panel 107 (e.g., the roof), and/or the state of construction of the RV 100 (e.g., cabinets or other furniture is already installed), without limit, it can become incredibly difficult to accurately position and/or plan out a cutout to avoid these components.

As used herein, “components” is to be interpreted to include at least one and/or any combination of those frame elements and “other components”discussed above.

It is also contemplated that “avoiding components” here, in this sense, includes not just the avoidance of cutting into the components and/or severing or otherwise destroying the components, but also the avoidance of forming cutouts/etc. in a way that may compromise the function and/or purpose of these components (e.g., removing the structural support for a mounting bracket).

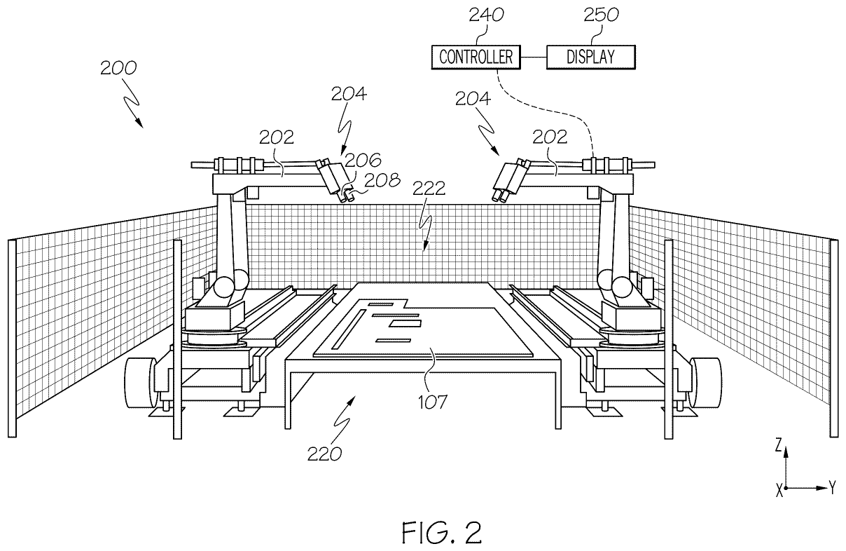

Turning now to FIGS. 2-3, an illustrative wall scanning system 200 for detecting these components within a body panel 107 of an RV so that they may be accurately avoided in subsequent fabrication steps is disclosed. The scanning system 200 may include one or more robotic arms 202, each robotic having one or more degrees of freedom and one or more tool ends 204 for mounting a tool. Each robotic arm 202 may be operated by a controller (e.g., a controller of the robotic arm itself 202, a controller of the scanning system 200, and/or some combination thereof) according to a predetermined operational program through which the robotic arm 202 may move about one or more axis and/or through one or more degrees of freedom to position the tool end 204 at or to move the tool end 204 between one or more predetermined locations.

The one or more tools mounted to the tool end 204 of the robotic arm 202 may include a penetrative imaging sensor 206 and a fabrication tool 208, in any number and/or combination. Fabrication tool 208 may include any combination of a cutting tool (e.g., a mechanical cutting tool such as a circular saw, jigsaw, Sabre saw, and/or the like; a thermal cutting tool such as a plasma torch or laser cutting head; a fluid cutting tool such as a waterjet or cryo jet; a hot wire; and/or the like, without limit), a drilling tool, a welding tool, a finishing tool (e.g., sander, polisher, and/or the like, without limit), a milling tool, a riveting tool, a gripping tool (e.g., mechanical, pneumatic, and/or the like, without limit), a manipulation tool (e.g., pincers, claws, hands/fingers, and/or the like), and/or the like, and in any combination, without limit. Each robotic arm 202 may have only one tool mounted at the tool end 204 and/or may have multiple tools simultaneously mounted at the tool end 204. In some aspects, those tools mounted to the tool end 204 may be rotated to “select” or otherwise operatively position a particular tool for use. In some aspects, the robotic arm 202 may interact with a tool changer or tool exchange system (not shown) to change out which tool and/or tools are attached to the tool end 204.

In some aspects, a first robotic arm 202 may have a first type of tool attached to the tool end 204 (e.g., a penetrative imaging sensor 206) while a second robotic arm 202 may have a second type of tool attached to the tool end 204 (e.g., a fabrication tool 208). In some aspects, a given robotic arm 202 may have both a penetrative imaging sensor 206 and a fabrication tool 208 attached to the tool end 204.

In some aspects, one or more robotic arms 202 are statically mounted relative to a workstation 212 (e.g., a work table, an articulated work table, a conveyor belt, overhead conveyor system, and/or the like, without limit). In some aspects, one or more robotic arms 202 are movably and/or translatably mounted (e.g., via a set of tracks 210, wheels 214, guiderails, and/or the like, and/or some combination thereof, without limit) relative to the workstation 212. In some aspects, the workstation 212 is displaceable relative to one or more robotic arms 202. In any case, each robotic arm 202 may dispose the tool end 204 through an entire work area 213 of the workstation 212 and/or through only some subpart thereof. In some aspects, the work area 213 is delimited at least partially by a barrier 215, fence, cordon, laser curtain, and/or the like, without limit.

In some aspects, the workstation 212 is a single “stop” or station along a longer conveyor belt or conveyor system. In some aspects, the workstation 212 receives a body panel 107 from a conveyor belt or conveyor system through a work area entrance 220. In some aspects, the workstation 212 discharges and/or transfers the body panel 107 to a conveyor belt or conveyor system through a work area exit 222. Accordingly, it may be appreciated that the scanner system 200 and/or the workstation 212 may, in some aspects, be part of a larger assembly line or assembly process. In some aspects, the workstation 212 is merely a spot at which an otherwise finished RV (e.g., for purposes of a retrofit and/or aftermarket addition), is parked, jacked, and/or the like, relative to the one or more robotic arms 202.

In some aspects, the body panel 107 and/or RV 100 may be worked using the scanning system 200 while stationary at the workstation 212. In some aspects, the body panel 107 and/or the RV 100 may be worked using the scanning system 200 while moving along a conveyor belt or conveyor system, e.g., as a continuous process.

In any case, once the body panel 107 is disposed in work area 213 and/or supported by the workstation 212 (e.g., placed upon the workstation or hung therefrom), one or more robotic arms 202 may be controlled to scan and/or perform one or more fabrication steps upon the body panel 107 using one or more tools. As discussed in greater detail below, one or more robotic arms 202 with scanners may scan the body panel 107 along one or more predetermined paths to identify the location and/or extent of components within and/or behind the body panel 107 that need to be avoided when conducting certain fabrication steps that might damage or otherwise disrupt the components. Once identified, the scanning system 200 may plan and/or determine a suitable tooling path for carrying out the fabrication step (e.g., cutting a window cutout 225 and/or a wheel well cutout 227) that avoids such components.

Scanning system 200 may further include at least one controller 240 for controlling the workstation 212, any conveyors, and/or the one or more robotic arms 202, in any combination, without limit. The controller 240 may include one or more processors, one or more memory units, one or more storage units, one or more interfaces (e.g., user interfaces, such as touchscreen, mouse and keyboard, training pendant, and/or the like, without limit), one or more displays, and/or one or more data and/or network interfaces, and/or the like, without limit. The one or more memory and/or storage units of the controller 240 may be a non-transitory computer readable storage medium that containing instructions that, when executed by the one or more processors, cause the controller 240 to control the scanner system 200 to carry out one or more of those functions and/or steps disclosed herein. Controller 240 may be communicatively coupled with a graphical display 250. Graphical display 250 may be part of the controller 240 or separate therefrom.

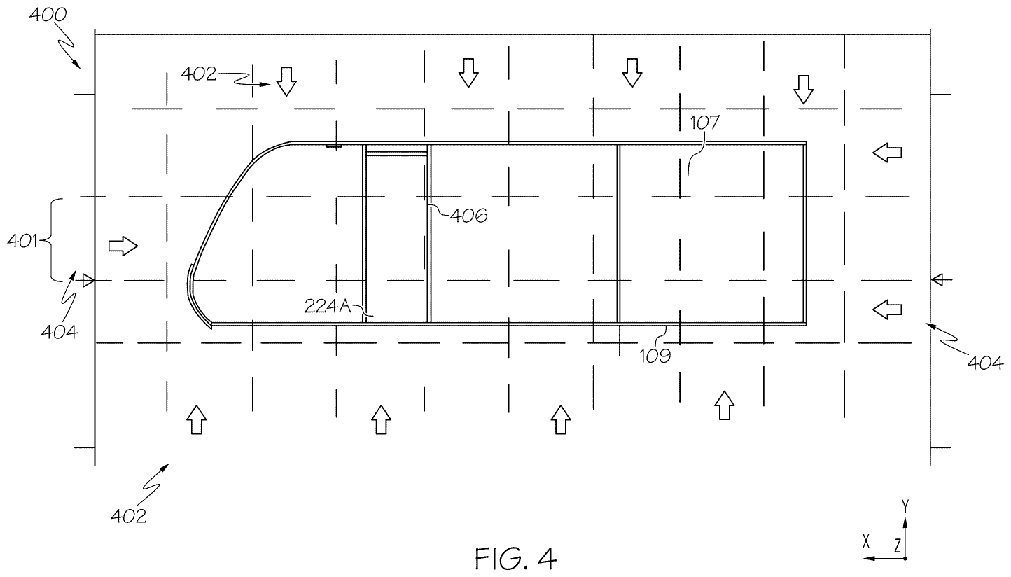

Turning now to FIG. 4, with continued reference to FIGS. 1-3, an illustrative planning chart 400 for scanning and fabricating a body panel 107 of an RV 100 is shown. The body panel 107 may be scanned with the penetrative imaging sensor 206 by controlling one or more robotic arms 202 to move one or more penetrative imaging sensors 206 relative to the body panel 107 according to one or more scan paths, including one or more horizontal scan paths and one or more vertical scan paths, and/or some combination thereof, to detect one or more components 406 (e.g., wiring, piping, supports, door frames, and/or the like, as discussed above). It may be appreciated that, though the scan paths of FIG. 4 are laid out in a grid like manner, scan paths may follow any arbitrary shape, line, or curve, and in any number, without deviating from the spirit of this disclosure. In some aspects, scan paths, such as vertical scan paths 402 and/or horizontal scan paths 404, are separated by a scan separation distance 401. Scan paths may be predetermined (e.g., the paths may be laid out in a grid or other predetermined pattern, the paths may follow a predetermined course, and/or the like, without limit) or dynamically determined based on readings received from the penetrative imaging sensor 206 (e.g., if wiring would continue past the field of view of a currently planned scan path(s), the robotic arm 202 may be controlled to expand and/or add one or more scan paths). In some aspects, the entirety of the body panel 107 is scanned by the scanning system 200. In some aspects, only a portion of the body panel 107 and/or an area of particular interest (e.g., an intended area at which a door cutout 224A is to be made) is scanned. In some aspects, the body panel 107 is scanned until a certain feature (e.g., the door cutout 224A, a door support frame 406, outer frame 109, and/or the like) has been fully mapped and/or scanned. In some aspects, the length and/or strategy of one or more scan paths may be optimized to reduce overall scanning time.

In some aspects, the planning chart 400 of FIG. 4 may additionally and/or alternatively be and/or serve as the basis for a graphical display that shows the results of an ongoing or complete scanning operation. In this way, the location of components 406 may be highlighted upon the display as they are detected, such as by displaying the scanner results as-is and/or by overlaying the scanner results over and/or with an image of the body panel 107.

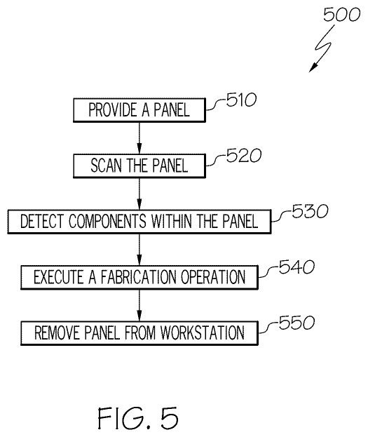

Turning now to FIG. 5, with continued reference to FIGS. 1-4, an exemplary method for fabricating a body panel 107 of an RV 200 is shown.

In step 510, the body panel 107 may be provided, such as by placing the body panel 107 on a workstation 212 in the work area 213, conveying the body panel 107 into and/or through the work area 213, parking the RV 100 in the work area 213, and/or the like, within workable range of one or more robotic arms 202 having one or more tools mounted to a tool end thereof 204.

In step 520, the one or more robotic arms 202 are controlled to scan the body panel 107 with at least one penetrative imaging sensor 206 by moving the penetrative imaging sensor(s) 206 along one or more scanning paths relative to the body panel 107. As noted above, the scanning paths may be predetermined and/or may be dynamically determined based at least in part on data collected by the penetrative imaging sensor 206. For example, the scanning system 200 may be controlled to detect the outer frame 109 of the body panel 107, and in turn scans along a first scan path until the outer frame 109 is detected, at which point the scan path is dynamically adjusted to follow the outer frame 109. As also noted above, the body panel 107 may be stationary or may remain moving during this step.

It should be noted that, though the body panel 107 is depicted as being flat or substantially flat within the figures, the shape of body panel 107 is not so limited. Body panel 107 may be curved, straight, bulky, thin, and/or the like, without limit. In some aspects, body panel 107 does not sit flat upon the workstation 212 and/or may not hang straight from a conveyor. Accordingly, the scan paths may accommodate these contours and/or shapes so that the penetrative imaging sensor(s) 206 can be maintained at a functional distance from a surface of the body panel 107 throughout the scan path.

In step 530, data collected by the penetrative imaging sensor(s) 206 is evaluated to determine the location of one or more components 406 within and/or behind the body panel 107. That is to say, the penetrative imaging sensor(s) 206 may, through various means, detect the presence of wood, metal, plastic, and/or the like, within and/or behind the body panel 107.

In an optional step 535, data collected by the penetrative imaging sensor(s) 206 may be output to a graphical display to allow an operator to monitor the scanning process and/or to approve a subsequent fabrication operation. In some aspects, an operator may use the graphical interface to plan out and/or to manually set a subsequent fabrication operation.

In step 540, one or more fabrication operations are carried out based at least in part upon the locations of one or more components 406 measured by the one or more penetrative imaging sensor(s) 206. That is to say, the body panel 107 may be cut, drilled, welded, riveted, and/or the like, without limit, while using the data collected by the penetrative imaging sensor(s) 206 to avoid the one or more components 406. In some aspects, the position and/or dimensions of the fabrication operation may be adjusted to avoid the one or more components 406. In some aspects, a fabrication operation template (e.g., one of a plurality of predetermined cutout shapes and/or cutout positions, without limit) may be selected to avoid the one or more components 406. In some aspects, the scanning system 200 may determine the extent of the one or more components 406 and plan the fabrication operation to avoid, circumscribe, and/or the like, without limit, the one or more components 406.

In some aspects, step 540 further comprises switching a tool at the tool end 204 of a robotic arm 202, such as by rotating a tooling assembly disposed at the tool end 204 and/or by exchanging a tool with a tool exchanger. In some aspects, the same robotic arm 202 that is used to at least partially scan the body panel 107 is also used to carry out the fabrication operation. In some aspects, a different robotic arm 202 than that used to at least partially scan the body panel 107 is used to carry out the fabrication operation.

In step 550, the body panel may optionally be removed from the workstation 212. In some aspects, removal of the body panel 107 from the workstation 212 and/or work area 213 includes conveying the body panel 107 out of the work area 213 and/or to continue along a fabrication and/or assembly line.

It should now be understood that aspects of the present disclosure are directed to a scanner system and methods carried out thereby for scanning a body panel of an RV to identify components that may be disposed within and/or behind said body panel for the purposes of planning and carrying out a fabrication operation (e.g., cutting) so that the component may be suitably avoided by the fabrication operation.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While several aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific aspects described herein. It is, therefore, to be understood that the foregoing aspects are presented by way of example only and that, within the scope of the appended claims and equivalents thereto, aspects may be practiced otherwise than as specifically described and claimed. Aspects of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one aspect, to A only (optionally including elements other than B); in another aspect, to B only (optionally including elements other than A); in yet another aspect, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of. ” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one aspect, to at least one, optionally including more than one, A, with no B present (and optionally including elements other than B); in another aspect, to at least one, optionally including more than one, B, with no A present (and optionally including elements other than A); in yet another aspect, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the aspects are not limited in its application to the details of construction and the arrangement of components set forth in the description or illustrated in the drawings. The invention is capable of other aspects and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several aspects of the invention has been presented for purposes of illustration. It is not intended to be exhaustive or to limit the invention to the precise structure, steps, and/or forms disclosed, and obviously many modifications and variations are possible in light of the above teaching.

1. A scanner system for scanning a body panel of an RV, the system comprising:
a workstation for supporting the body panel of the RV;
at least one industrial robot equipped with at least one penetrative imaging sensor for scanning the body panel; and
a controller, wherein the controller is configured to:
control the industrial robot to scan the body panel with the penetrative imaging sensor,
identify at least one component within or behind the body panel that is detectable by the at least one penetrative imaging sensor, and
plan a fabrication operation based at least in part on a detected location of the at least one component.

2. The scanner system of claim 1, wherein the at least one industrial robot is equipped with at least one fabrication tool for performing a fabrication operation on the body panel.

3. The scanner system of claim 2, wherein a first of the at least one industrial robot comprises both the at least one penetrative imaging sensor and the at least one fabrication tool.

4. The scanner system of claim 2, wherein the at least one industrial robot is at least two industrial robots, a first of the at least two industrial robots comprises the at least one penetrative imaging sensor, and a second of the at least two industrial robots comprises the at least one fabrication tool.

5. The scanner system of claim 2, wherein the controller is further configured to control the at least one industrial robot to carry out the fabrication operation.

6. The scanner system of claim 1, wherein the work surface is a conveyor belt configured to convey the body panel to and/or from a work area in which the at least one industrial robot is disposed.

7. The scanner system of claim 1, wherein the controller is further configured to control the robot to scan the body panel along a predetermined scan path.

8. The scanner system of claim 1, wherein the controller is further configured to dynamically adjust a scan path traced by the penetrative imaging sensor based at least in part on the detected location of the at least one component.

9. The scanner system of claim 1, wherein the controller is configured to display on a graphical interface the detected location of the at least one component.

10. The scanner system of claim 1, wherein the at least one component comprises metal.

11. The scanner system of claim 1, wherein the penetrative imaging sensor is a capacitive sensor.

12. The scanner system of claim 1, wherein the penetrative imaging sensor is an inductive sensor.

13. A method for scanning a body panel of an RV, the method comprising the steps of:
disposing a body panel within a workable range of at least one industrial robot;
scanning the body panel with at least one penetrative imaging sensor attached to the at least one industrial robot;
identifying at least one component within or behind the body panel that is detectable by the at least one penetrative imaging sensor; and
planning a fabrication operation based at least in part on a detected location of the at least one component.

14. The method of claim 13, further comprising carrying out the fabrication operation with at least one fabrication tool attached to the at least one industrial robot.

15. The method of claim 14, wherein a first of the at least one industrial robot comprises both the at least one penetrative imaging sensor and the at least one fabrication tool.

16. The method of claim 14, wherein the at least one industrial robot is at least two industrial robots, a first of the at least two industrial robots comprises the at least one penetrative imaging sensor, and a second of the at least two industrial robots comprises the at least one fabrication tool.

17. The method of claim 13, further comprising conveying the body panel through the workable range of the at least one industrial robot.

18. The method of claim 13, wherein the body panel is scanned according to a predetermined scan path.

19. The method of claim 13, wherein a scan path traced by the penetrative imaging sensor is dynamically adjusted based at least in part on the detected location of the at least one component.

20. The method of claim 13, further comprising displaying on a graphical interface the detected location of the at least one component.
